(19) United States
(12) Patent Application Publication
(10) Pub. No.: US 2024/0334039 A1
(43) Pub. Date: Oct. 3, 2024

(54) ELECTRONIC APPARATUS, CONTROL METHOD THEREFOR, AND STORAGE MEDIUM

(71) Applicant: CANON KABUSHIKI KAISHA, Tokyo (JP)

(72) Inventors: HIROSHI TORIUMI, Kanagawa (JP); TAKAYUKI HOSHINA, Kanagawa (JP)

(21) Appl. No.: 18/617,340

(22) Filed: Mar. 26, 2024

(30) Foreign Application Priority Data
Mar. 28, 2023 (JP) 2023-051689
Dec. 27, 2023 (JP) 2023-222018

(51) Int. Cl. H04N 23/61; G06V 10/60; G06V 40/16

(52) U.S. Cl. CPC H04N 23/61; G06V 10/60; G06V 40/174; G06V 2201/07

(57) ABSTRACT

An electronic apparatus includes an operation unit configured to output a first operation instruction instructing preparation for shooting, and a second operation instruction instructing recording of a captured image; an identification unit configured to identify a subject; a control unit configured to, while the first operation instruction is being output, execute control to capture the image data by the imaging unit and retain the image data in a storage unit based on identification information of the identification unit; and a recording unit configured to, when the second operation instruction is output, record, onto a recording medium, image data of an image captured by the imaging unit in response to the second operation instruction, and image data retained in the storage unit at a timing closest to when the second operation instruction is output.

### BACKGROUND

### Field of the Disclosure

The present disclosure relates to electronic apparatuses, control methods therefor, and storage media, and particularly to shooting control technology in electronic apparatuses.

### Description of the Related Art

Hitherto, in electronic apparatuses that have imaging functions such as digital cameras, there has been a time lag between the photographer pressing the camera's release button to give a shooting instruction and the actual start of the shooting and recording, which sometimes results in the photographer being unable to capture the desired image.

To handle such issues, Japanese Patent Laid-Open No. 2002-252804 proposes a camera equipped with a pre-capture function. The pre-capture function is a function that, while the first stage of the release button is being pressed, performs repeated shooting to save a certain number of images of quality equivalent to still images in the buffer memory. Then, at the time point at which the second stage of the release button is pressed, the images saved in the buffer memory and the image captured at the time point at which the second stage of the release button is pressed are saved in the recording medium.

Utilizing the pre-capture function as described above allows for retrospective shooting and recording from the moment the photographer issues a shooting instruction, thus enabling the photographer to capture the desired image.

While the pre-capture function more reliably enables recording of irregular and rapid movements that cannot be handled by human reaction speeds, the camera consumes more power because it shoots and records images retrospectively from the moment the photographer issues a shooting instruction. Therefore, in order to reduce the battery consumption of the camera, it is necessary for the photographer to switch the pre-capture function on and off. However, in a shooting scene for capturing irregular and rapid movements that cannot be handled by human reaction speeds, it requires the photographer to perform operations, who may end up missing the opportunity to give a shooting instruction.

### SUMMARY

Embodiments of the present disclosure have been made in consideration of the above situation, and provide an electronic apparatus capable of effectively using a pre-capture function without requiring operation by a photographer, a control method therefor, and a storage medium.

According to embodiments of the present disclosure, provided is an electronic apparatus including: an operation unit configured to output a first operation instruction instructing preparation for shooting, and a second operation instruction instructing recording of a captured image; a storage unit configured to temporarily retain image data output from an imaging unit while the first operation instruction is being output; an identification unit configured to identify a subject; a control unit configured to, while the first operation instruction is being output, execute control to capture the image data by the imaging unit and retain the image data in the storage unit based on identification information of the identification unit; and a recording unit configured to, when the second operation instruction is output, record, onto a recording medium, image data of an image captured by the imaging unit in response to the second operation instruction, and image data retained in the storage unit at a timing closest to when the second operation instruction is output.

Further features of the present disclosure will become apparent from the following description of exemplary embodiments with reference to the attached drawings.

### BRIEF DESCRIPTION OF THE DRAWINGS

FIG. 1 is a block diagram illustrating an example of the hardware configuration of an imaging apparatus according to a first embodiment.

FIG. 2 is a flowchart illustrating the processing operation of the imaging apparatus according to the first embodiment.

FIG. 3 is a table illustrating the pre-capture settings of the imaging apparatus according to the first embodiment.

FIG. 4 is a block diagram illustrating an example of the hardware configuration of an imaging apparatus according to a second embodiment.

FIG. 5 is a flowchart illustrating the processing operation of the imaging apparatus according to the second embodiment.

FIGS. 6A to 6D are diagrams each illustrating the motion vector value of a main subject and the main subject temperature according to the second embodiment.

FIG. 7 is a flowchart illustrating the processing operation of an imaging apparatus according to a third embodiment.

FIG. 8 is a diagram illustrating the relationship among multiple imaging apparatuses according to the third embodiment.

FIG. 9 is a table illustrating the pre-capture settings of the imaging apparatus according to the second embodiment.

### DESCRIPTION OF THE EMBODIMENTS

Embodiments will now be described in detail with reference to the accompanying drawings. Note that the following embodiments are not construed to limit the disclosure. Although the embodiments describe multiple features, not all of these features are essential to the disclosure, and the features may be combined in any manner. Furthermore, identical or similar configurations are given the same reference numerals in the accompanying drawings, and duplicate descriptions are omitted.

### First Embodiment

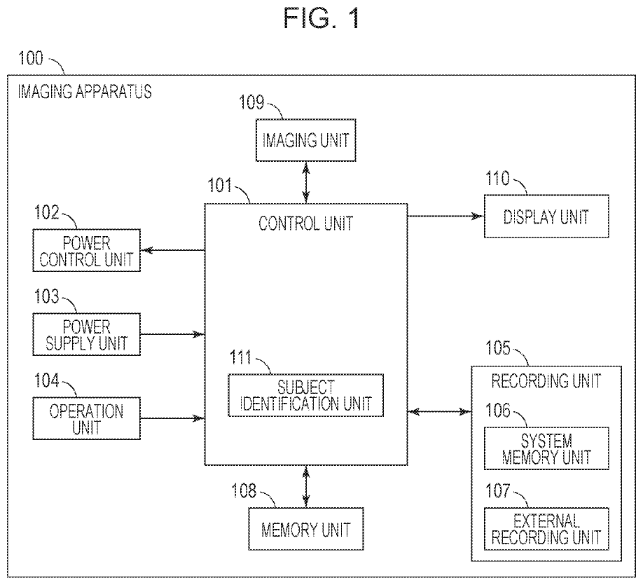

FIG. 1 is a block diagram illustrating the hardware configuration of an imaging apparatus 100 according to a first embodiment. Note that the imaging apparatus 100 may simply be an electronic apparatus equipped with a camera function, which may be a camera such as a digital camera and a digital video camera, or a mobile phone with a camera, a computer with a camera, a game machine, or the like.

A control unit 101 controls the operation of the entire imaging apparatus 100 and is composed of at least one processor. The control unit 101 controls the entire imaging apparatus 100 by reading a program for controlling the imaging apparatus 100 from a memory unit 108 and expanding a part of the program onto a system memory unit 106.

A power control unit 102 is composed of a battery detection circuit, a protection circuit, a direct current (DC)-DC converter, a low dropout (LDO) regulator, and the like, and converts the power supplied from a power supply unit 103 to a voltage suitable for each electronic device included in the imaging apparatus 100 and supplies it. In addition, the power control unit 102 has functions such as detecting whether a battery is attached, detecting the type and remaining amount of the battery, and protecting a load circuit connected to the power supply circuit by disconnecting power when overcurrent is detected. The power control unit 102 further has a power detection circuit capable of detecting the amount of power supplied to each unit in the imaging apparatus 100.

The power supply unit 103 is composed of a secondary battery such as a NiCd battery, a NiMH battery, or a Li battery, an alternating current (AC) adapter, and the like. The power supply unit 103 further has a circuit for obtaining the battery remaining amount, and can notify the control unit 101 of the obtained battery remaining amount through communication.

An operation unit 104 has an operation member for inputting various operation instructions to the control unit 101. The operation unit 104 is composed of any one of, or a combination of, a switch, a dial, a touchscreen, a voice recognition device, and the like. A release button, which is one element of the operation unit 104, is composed of two-stage switches consisting of a first release switch and a second release switch. With a first-stage pressing operation (e.g., half-pressing), the first release switch is turned on (first detection), and a first operation instruction instructing preparation for shooting is output to the control unit 101.

Furthermore, with a second-stage pressing operation (e.g., full pressing), the second release switch is turned on (second detection), and a second operation instruction instructing recording of a captured image is output to the control unit 101. Note that the operation member outputting the first operation instruction and the second operation instruction is not limited to the release button; it can have any configuration that allows the output of the first operation instruction and the second operation instruction.

A recording unit 105 is configured including the system memory unit 106 and an external recording unit 107.

The system memory unit 106 is composed of RAM and the like, and is used to expand a program read out from the memory unit 108, constants and variables for the operation of the control unit 101, and the like. Additionally, before the actual shooting, pre-capture shooting is repeatedly performed, which captures images of quality equivalent or nearly equivalent to the image obtained by the actual shooting, and the image data of the images obtained from the pre-capture shooting (hereinafter referred to as “pre-capture images”) are sequentially and temporarily retained in the system memory unit 106. Then, when a predetermined number of pre-capture images are retained, the oldest retained pre-capture image is deleted and a new pre-capture image is retained. The external recording unit 107 is a detachable recording medium such as a semiconductor memory. The external recording unit 107 records, of the pre-capture images saved in the system memory unit 106, the image data of the pre-capture images captured at a timing closest to when the second operation instruction is output, as well as the image data of the image obtained by the actual shooting.

The memory unit 108 is composed of an electrically erasable and recordable non-volatile memory, ROM, and the like, and stores constants, programs, etc. for the operation of the control unit 101. The programs mentioned here include a program for executing a process illustrated in a later-described flowchart in the present embodiment.

An imaging unit 109 is composed of an image sensor such as a complementary metal-oxide-semiconductor (CMOS) sensor or a charge-coupled device (CCD), executes shooting based on instructions of the control unit 101, and sends information (image data, etc.) of the captured image to the control unit 101.

A display unit 110 is a device equipped with a liquid crystal display, a loudspeaker, etc., which displays operational states, messages, etc., such as characters, images, and audio, in response to the execution of programs by the control unit 101. The display unit 110 is composed of a combination of an electronic view finder (EVF), a liquid crystal display (LCD), a light-emitting diode (LED), a sound-emitting element, and the like.

A subject identification unit 111 is a component that identifies the subject of a subject image formed by the imaging unit 109. Examples of subjects include people, vehicles, animals, landscapes, and so on.

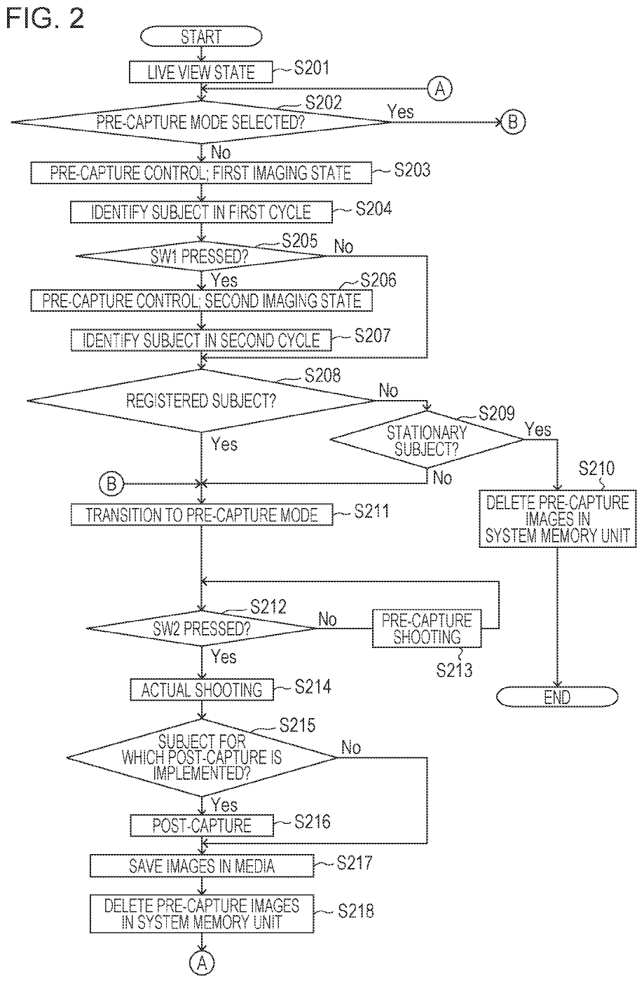

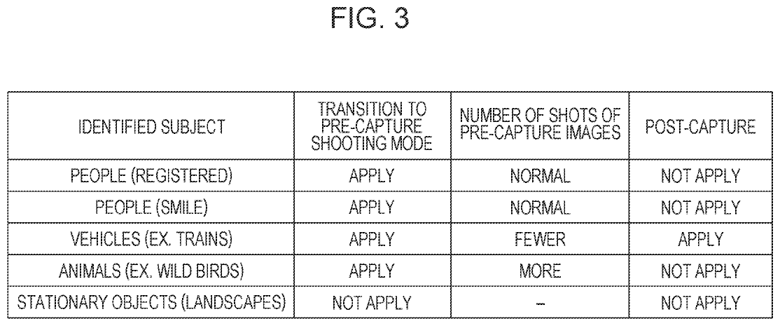

Hereinafter, an imaging process in the first embodiment, which is performed by the imaging apparatus 100 having the above configuration, will be described with reference to FIGS. 2 and 3. Here, each action in the flowchart of FIG. 2 is realized by the control unit 101 of the imaging apparatus 100 expanding a program stored in the memory unit 108 onto the system memory unit 106 and executing it to control each function block.

In S201, the imaging apparatus 100 is in a live view state to display a live view image obtained from the imaging unit 109.

In S202, the control unit 101 determines whether the imaging apparatus 100 is set to a pre-capture shooting mode. If the imaging apparatus 100 is set to the pre-capture shooting mode, the control unit 101 transitions to S211, and if the imaging apparatus 100 is not set to the pre-capture shooting mode, the control unit 101 transitions to S203. The setting of the pre-capture shooting mode in the present embodiment does not require the photographer's operation due to the flow described later, and is set (switched) automatically. Note that it is also possible for the photographer to manually set (enable/disable) the pre-capture shooting mode using the operation unit 104.

In S203, the control unit 101 controls the imaging unit 109 to a first imaging state. The first imaging state and a later-discussed second imaging state will now be described. The first imaging state is a live view state in S201, and is an imaging state in a mode in which the photographer monitors a subject image. In contrast, the second imaging state is an imaging state in which the photographer presses the first release switch of the operation unit 104 to perform autofocus control on the subject image. For autofocus control, there are methods such as contrast AF (also referred to as hill-climbing AF), which is based on the contrast of a subject image captured by the imaging unit 109, and phase difference AF, which determines the direction and amount of focus based on the interval between two formed images. In either method, during autofocus, the driving mode of the imaging unit 109 is in a state where the driving frequency (frame rate) is higher and the resolution in the horizontal and vertical directions is higher than those in the live view state, which is the first imaging state. Therefore, there is a higher probability that the focus is on the subject in the second imaging state, and the accuracy of subject identification is also higher, as compared to the first imaging state, which is in the live view state.

In S204, the control unit 101 performs subject identification at a first cyclic interval and obtains identification information using the subject identification unit 111. In the first imaging state, because the probability that the focus is on the subject is lower compared to the second imaging state, the cycle of subject identification is also reduced. For example, it may be controlled to identify the subject in cycles of several seconds.

In S205, the control unit 101 determines whether the first release switch of the operation unit 104 is pressed. If the first release switch is pressed, the control unit 101 transitions to S206, and if it is not pressed, the control unit 101 transitions to S208.

In S206, the control unit 101 controls the imaging unit 109 to the second imaging state.

In S207, the control unit 101 performs subject identification at a second cyclic interval using the subject identification unit 111. In the second imaging state, because the probability that the focus is on the subject is higher compared to the first imaging state, the cycle of subject identification is also increased. For example, it may be controlled to identify the subject in cycles of several frames (several times per second).

In S208, the control unit 101 determines whether the subject identified by the subject identification unit 111 is a subject registered in the memory unit 108. If it is registered, the control unit 101 transitions to S211, and if it is not registered, the control unit 101 transitions to S209.

In S209, the control unit 101 determines whether the subject identified by the subject identification unit 111 is a stationary subject. If it is determined to be a stationary subject, the control unit 101 transitions to S210, and if it is not determined to be a stationary subject, the control unit 101 transitions to S211.

In S211, the control unit 101 transitions to a pre-capture mode.

FIG. 3 is now used to supplement the description of S208 and S209. FIG. 3 is a table illustrating the settings of the imaging apparatus 100 regarding “whether to transition to the pre-capture shooting mode, the number of shots of pre-capture images, and whether to implement post-capture” according to the identified subject. Situations for using the pre-capture function are assumed to include shooting scenes for capturing images of fast-moving vehicles or the moment when a stationary bird flies away. In other words, it is important to identify whether the subject is a moving subject. S208 indicates a case where the identified subject is a person (registered) in FIG. 3. The person is a moving subject, and, in order to prevent the loss of the opportunity for giving a shooting instruction, the pre-capture setting is configured. Note that, in the present embodiment, it is assumed that the pre-capture setting is configured only for people registered in the memory unit 108, but a configuration in which the pre-capture setting is configured regardless of whether the subject is registered or not is also conceivable. S209 indicates a case where the identified subject is a person (smile) in FIG. 3, and also a case where the identified subject is a vehicle (e.g., a train), an animal (e.g., a wild bird), or a stationary object (e.g., a landscape). A person (smile), a vehicle (e.g., a train), and an animal (e.g., a wild bird) are moving subjects, and, in order to prevent the loss of the opportunity for giving a shooting instruction, the pre-capture setting is configured (No in S209). Regarding a person (smile), even if it is determined in S208 that the person is an unregistered person, the smile is identified as the movement of the subject and the pre-capture setting is configured. In contrast, in the case of a stationary object (e.g., a landscape), since it is a non-moving subject, it is determined that there is no need to prevent the loss of the opportunity for giving a shooting instruction, and hence the pre-capture setting is not configured (Yes in S209). Note that the identification of a moving subject may be determined using the posture of the subject relative to the imaging apparatus 100. The posture of the subject mentioned here is determined using, for example, local tracking (e.g., face tracking) and/or global tracking (e.g., skeletal tracking) to detect the position and/or orientation of the subject in the scene relative to the imaging apparatus 100.

Referring back to the flow, in S210, the control unit 101 deletes all of the pre-capture images recorded in the system memory unit 106. S210 is a case where no pre-capture shooting is performed, and the flow ends.

In S212, the control unit 101 determines whether the second release switch of the operation unit 104 is pressed. If the second release switch is pressed, the control unit 101 transitions to S214, and if it is not pressed, the control unit 101 transitions to S213.

In S213, the control unit 101 performs pre-capture shooting. The control unit 101 returns to S212 to repeat the same or similar process.

The pre-capture shooting will now be described. In the pre-capture shooting, while pressing of the first release switch of the operation unit 104 is being detected, an imaging operation is continuously performed, and captured images whose quantity is the certain number of pre-capture shots are temporarily recorded as pre-capture images in the system memory unit 106. If the maximum number of pre-capture shots are reached when recording a newly captured image in the system memory unit 106, the oldest one is deleted and the latest captured image is recorded in the system memory unit 106.

Note that the number of pre-capture shots in the present embodiment is set according to the setting of the number of shots of pre-capture images in FIG. 3. If the identified subject is a person (registered) or the identified subject is a person (smile), the number of shots is set to the normal number of shots. In the case of a person, the number of shots equivalent to several seconds serves as the normal setting. If the identified subject is a vehicle (e.g., a train), the movement of the subject is easy to capture, and it is possible to give a shooting instruction assuming the movement of the subject; thus, the number of shots is set to be lower than the normal setting. Of course, it may be configured to set the number of shots to the normal setting. If the identified subject is an animal (e.g., a wild bird), it is difficult to capture the movement of the subject, and it is difficult to give a shooting instruction assuming the movement of the subject; thus, the number of shots is set to be higher than the normal setting. The number of shots equivalent to several to ten seconds or so is set.

In S214, the control unit 101 performs the actual shooting. Here, unlike the pre-capture shooting, the actual shooting is normal single-shot shooting, capturing an image for one frame.

If the control unit 101 determines in S215, using the subject identification unit 111, that the subject is a subject for which post-capture is implemented, the control unit 101 transitions to S216, and if the subject is determined to be a subject for which no post-capture is implemented, the control unit 101 transitions to S217.

Note that post-capture in the present embodiment indicates that, in the actual shooting in S214, the photographer continues shooting for a certain number of shots after pressing the second release switch. Note that whether to implement post-capture is set according to the post-capture setting in FIG. 3. If the identified subject is a person (registered), a person (smile), an animal (e.g., a wild bird), or a stationary object (e.g., a landscape), because image shooting is not required after the photographer's shooting instruction, the setting is configured not to implement post-capture. In contrast, if the identified subject is a vehicle (e.g., a train), the subject moves fast; it is possible to give a shooting instruction assuming the movement of the subject, but the photographer may end up being unable to capture the image at the desired angle of view. Therefore, the setting is configured to implement post-capture, recording a certain number of images captured after the photographer's shooting instruction.

As for the number of shots, a quantity corresponding to several seconds is sufficient. As part of the control of the imaging apparatus 100, burst shooting is implemented following step S214.

In S217, if pre-capture images are recorded in the system memory unit 106, the control unit 101 saves the pre-capture images and the actual shooting image obtained in S214 in the external recording unit 107. Note that, if a post-capture image is obtained in S215, it is similarly saved in the external recording unit 107.

In S218, the control unit 101 deletes all of the pre-capture images recorded in the system memory unit 106. Thereafter, the control unit 101 returns to S202 to repeat the flow.

As described above, according to the present embodiment, by automatically enabling the pre-capture function based on the subject identification result, the photographer need not perform a camera operation, thereby preventing the loss of the opportunity for giving a shooting instruction.

### Second Embodiment

In the first embodiment, a method of identifying a subject from a subject image formed by the imaging unit 109 has been described. In a second embodiment, a method of subject identification using a sensor other than the imaging unit 109, such as an event sensor or a thermosensor, will be described.

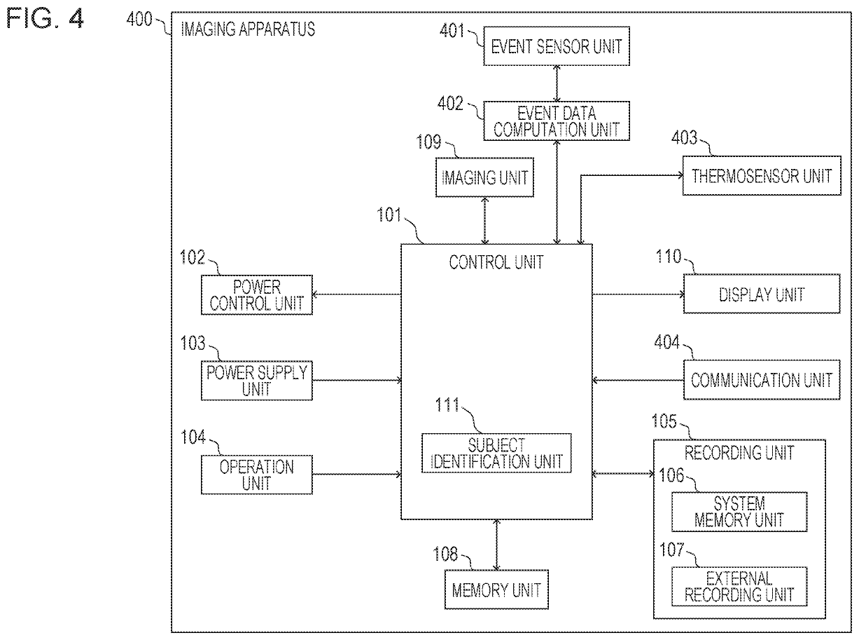

FIG. 4 is a block diagram illustrating the hardware configuration of an imaging apparatus 400 according to the second embodiment. An event sensor 401, an event data computation unit 402, a thermosensor unit 403, and a communication unit 404 have been added to the imaging apparatus 100 illustrated in FIG. 1. The rest of the configuration is the same as in FIG. 1, and description thereof is omitted.

The event sensor 401 is an event-based vision sensor configured to detect a luminance change of light incident on each pixel and to output information on pixels that have had a luminance change asynchronously with other pixels. Data output from the event sensor 401 (hereinafter referred to as event data) includes, for example, the position coordinates of the pixel where a luminance change (event) occurred, the polarity (positive/negative) of the luminance change, and timing information corresponding to the event occurrence time. The event sensor 401, compared to existing frame-based synchronous sensors, eliminates redundancy in the information to be output, and features high speed operation, high dynamic range, and low power consumption. In the meanwhile, the event data is data in which each pixel information is output asynchronously. In order to determine the correlation between items of event data, it is necessary to accumulate items of event data that occur during a certain period of time and perform various computational processes on the results.

The event data computation unit 402 is a computation unit configured to detect a motion vector of subject information based on items of event data continuously and asynchronously output from the event sensor 401. For example, by accumulating items of event data that occur during a certain period of time and processing them as a set of data, it is possible to determine the movement direction and velocity of the subject from the motion vector of the subject information.

The thermosensor unit 403 is a sensor for detecting the temperature of a subject, and, for example, is configured to detect the amount of infrared light reflected from the subject relative to the amount of infrared light irradiated towards the subject, which makes it possible to measure the temperature of the subject. The communication unit 404 can communicate with another imaging apparatuses 100. The communication unit 404 can also communicate a control signal from the imaging apparatus 100 serving as the master to another imaging apparatuses 100 serving as the slave to issue an instruction command, as described later. Communication between the communication unit 404 and another imaging apparatus 100 is performed by wireless communication (for example, Wi-Fi) or the like.

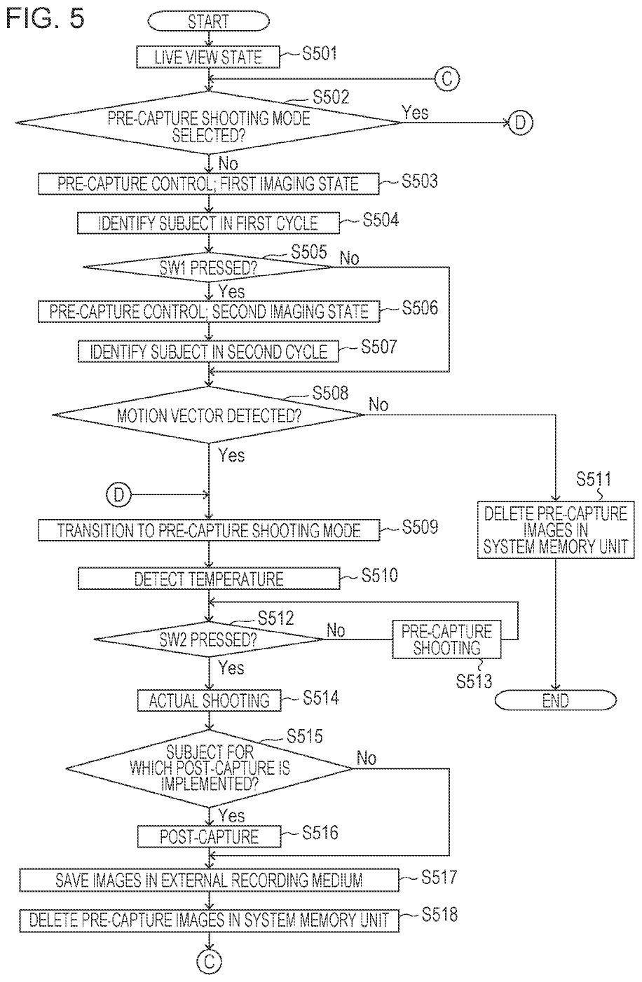

Referring now to FIGS. 5, 6A to 6D, and 9, a control method for the imaging apparatus 400 according to the second embodiment will be described. Here, each action in the flowchart of FIG. 5 is realized by the control unit 101 of the imaging apparatus 400 expanding a program stored in the memory unit 108 onto the system memory unit 106 and executing it to control each function block.

Since S501 to S507 in the flowchart of FIG. 5 are the same as S201 to S207 in the flowchart of FIG. 2, description thereof is omitted.

In S508, the control unit 101 transitions to S509 if the movement of the subject is detected based on the motion vector information of the subject computed by the event data computation unit 402, and transitions to S511 if the movement of the subject is not detected.

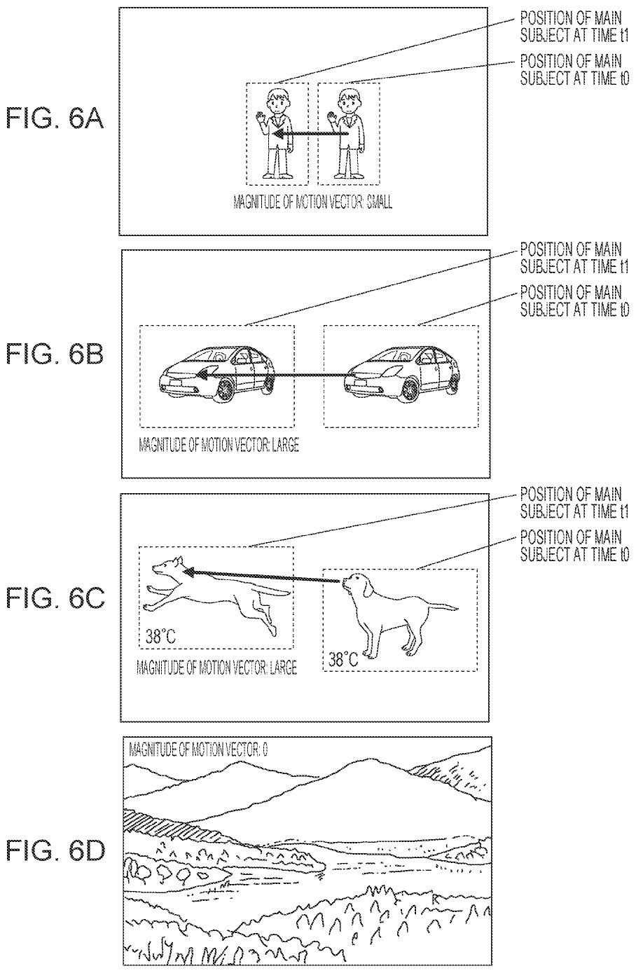

Note that the method of detecting and determining the movement of the subject will be described later using FIGS. 6A to 6D.

In S509, the control unit 101 causes the imaging apparatus 400 to transition to the pre-capture shooting mode.

In S510, the control unit 101 obtains the temperature of the subject obtained by the thermosensor unit 403.

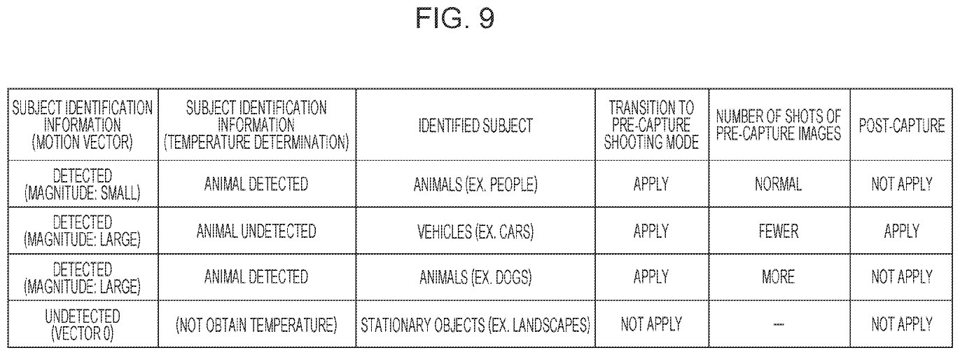

FIG. 9 will now be used to supplement the description of S508 to S510.

FIG. 9 is a table illustrating the settings of the imaging apparatus 400 regarding whether to transition to the pre-capture shooting mode, the number of shots, and whether to implement post-capture. As for these settings, the settings are switched depending on the motion vector information of the subject and the temperature of the subject. Note that, because the settings regarding whether to transition to the pre-capture shooting mode, the number of shots of pre-capture images, and whether to implement post-capture are the same as those in FIG. 3, description thereof is omitted.

The point that differs from FIG. 3 resides in the point that the event sensor 401 and the thermosensor unit 403 are used for subject identification, and FIGS. 6A to 6D illustrate examples of subject identification.

FIG. 6A is an image diagram of a configuration using the motion vector value of the present embodiment as the state information of the main subject. FIG. 6A is an image diagram that overlays frame images obtained at time t0 and time t1, detecting a motion vector value. Note that the magnitude of the motion vector |\vec{M}| in FIG. 6A is determined to be small because it is less than or equal to the magnitude of a first threshold vector |\vec{m1}| ((|\vec{M}|≤|\vec{m}|). Also illustrated is an example in which the body temperature of an animal is detected as the subject temperature. Although humans (35° C. to 37° C.) and dogs (38° C. to 39° C.) are used as examples of animals in the present embodiment, multiple methods of implementation are conceivable, such as grouping animals together, e.g., birds (40° C. to 42° C.) or mammals in general (35° C. to 45° C.). The example in FIG. 6A illustrates a case where, with a motion vector detected (small in magnitude) and an animal body temperature detected, the subject is determined to be an animal (e.g., a person).

FIG. 6B is an image diagram of a configuration using the motion vector value of the present embodiment as the state information of the main subject. FIG. 6B is an image diagram that overlays frame images obtained at time t0 and time t1, detecting a motion vector value. Note that the magnitude of the motion vector |\vec{M}| in FIG. 6B is determined to be large because it is greater than the magnitude of the certain threshold vector |\vec{m1}| (|\vec{M}|>|\vec{m1}|). Also illustrated is an example in which the body temperature of an animal is not detected as the subject temperature. The example in FIG. 6B illustrates a case where, with a motion vector detected (large in magnitude) and an animal body temperature undetected, the subject is determined to be a vehicle (e.g., a car).

FIG. 6C is an image diagram that overlays frame images obtained at time t0 and time t1, detecting a motion vector value. Note that the magnitude of the motion vector |\vec{M}| in FIG. 6C is determined to be large because it is greater than the magnitude of the certain threshold vector |\vec{m1}|(|\vec{M}|>|\vec{m1}|). Also illustrated is an example in which the body temperature of an animal is detected as the subject temperature. The example in FIG. 6C illustrates a case where, with a motion vector detected and an animal body temperature detected (38° C.), the subject is determined to be an animal (e.g., a dog).

FIG. 6D is an image diagram that overlays frame images obtained at time t0 and time t1, detecting no motion vector value. Note that the magnitude of the motion vector |\vec{M}| in FIG. 6D is determined using the magnitude of a second threshold vector |\vec{m2}| which is smaller than the magnitude of the first threshold vector |\vec{m1}|. The magnitude of the motion vector |\vec{M}| in FIG. 6D is less than or equal to the magnitude of the second threshold vector |\vec{m2}|((|\vec{M}|≤|\vec{m2}|)), where a motion vector is undetected (vector 0 (zero) is detected).

Moreover, since the magnitude of a motion vector is undetected in FIG. 6D and it is determined No in S508, subject temperature detection is not performed in S510. As a result, an example in which the subject is determined to be a stationary object (e.g., a landscape) is indicated.

Although two thresholds for the magnitude of a motion vector are provided in the present embodiment, categorizing the magnitude into three groups, namely, large motion vector magnitude, small motion vector magnitude, and zero motion vector magnitude, it is permissible to provide three or more thresholds for the magnitude of a motion vector. As described above, by identifying the subject from the sensor output results of the event sensor 401 and the thermosensor unit 403, the settings regarding “whether to transition to the pre-capture shooting mode, the number of shots of pre-capture images, and whether to implement post-capture” in FIG. 9 are determined.

Referring back to the flow of FIG. 5, because S511 to S518 are the same as S210 to S218 in the flowchart of FIG. 2, description thereof is omitted.

According to the present embodiment, by automatically enabling the pre-capture function based on the subject identification result using sensors other than the imaging unit 109, such as an event sensor and a thermosensor, the photographer need not perform a camera operation, thereby preventing the loss of the opportunity for giving a shooting instruction. Although the example in which both the event sensor and the thermosensor are used has been described in the above-described embodiment, the subject may be identified based on information from one of these sensors.

### Third Embodiment

In a third embodiment, when shooting with a plurality of imaging apparatuses using the pre-capture function, once a single imaging apparatus that acts as a master transitions to the pre-capture shooting mode, a method of causing the other imaging apparatuses that act as slaves to transition to the pre-capture shooting mode will be described.

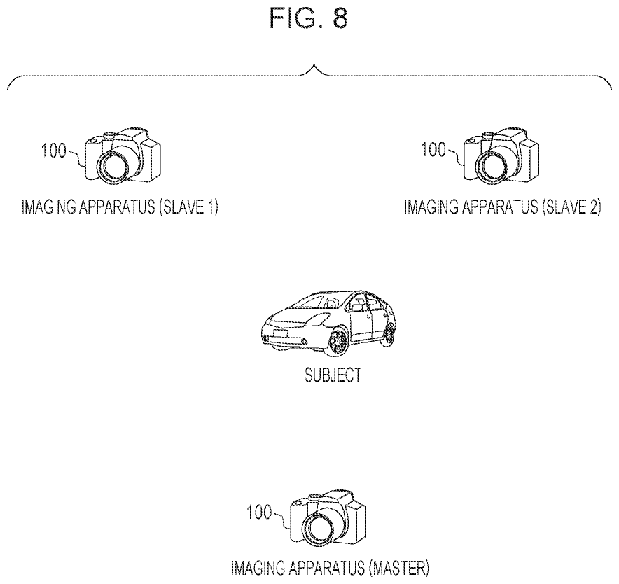

FIG. 8 is a diagram relating to an imaging system according to the third embodiment. In the present embodiment, an example will be described in which three imaging apparatuses are used, one imaging apparatus 100 acting as a master and the remaining two imaging apparatuses 100 acting as slaves.

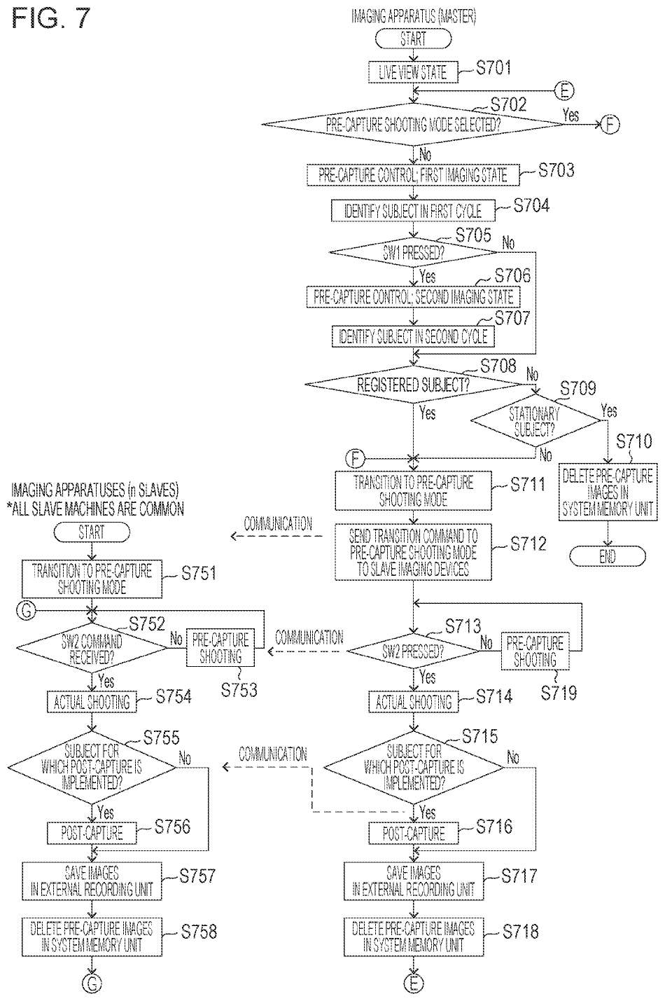

Hereinafter, a control method for the imaging apparatuses 100 according to the third embodiment will be described with reference to FIGS. 7 and 8. Here, each action in the flowchart of FIG. 7 is realized by the control unit 101 of each imaging apparatus 100 expanding a program stored in the memory unit 108 onto the system memory unit 106 and executing it to control each function block.

Since the actions in S701 to S711 in the master imaging apparatus 100 are the same as S201 to S211 in the flowchart of FIG. 2, description thereof is omitted. The flow after the master imaging apparatus 100 transitions to the pre-capture shooting mode in S711 will be described in detail.

In S712, the control unit 101 of the master imaging apparatus 100 issues a transition command to the pre-capture shooting mode, through the communication unit 404, to the two other imaging apparatuses 100 acting as slaves illustrated in FIG. 8.

In S751, the control unit 101 of each of the two other imaging apparatuses 100 acting as slaves transitions to the pre-capture shooting mode in accordance with the transition instruction to the pre-capture shooting mode received through the communication unit 404.

In S713, the control unit 101 of the master imaging apparatus 100 determines whether the second release switch of the operation unit 104 is pressed. If the second release switch is pressed, the control unit 101 transitions to S714. In addition, the control unit 101 of the master imaging apparatus 100 issues an instruction command to press the second release switch, through the communication unit 404, to the two other imaging apparatuses 100 acting as slaves. In contrast, if the second release switch is not pressed, the control unit 101 transitions to S719.

In S719, the control unit 101 of the master imaging apparatus 100 performs pre-capture shooting. The control unit 101 then returns to S713 to repeat the same or similar process.

In S714, the control unit 101 of the master imaging apparatus 100 performs the actual shooting. Here, unlike the pre-capture shooting, the actual shooting is normal single-shot shooting, capturing an image for one frame.

In contrast, in S752, the control unit 101 of each of the imaging apparatuses 100 acting as slaves determines whether an instruction command to press the second release switch has been received from the master imaging apparatus 100. If an instruction command to press the second release switch has been received, the control unit 101 transitions to S754. In contrast, if an instruction command to press the second release switch has not been received, the control unit 101 transitions to S753. In S753, the control unit 101 of each of the two imaging apparatuses 100 acting as slaves performs pre-capture shooting. Thereafter, the control unit 101 returns to S752 to repeat the same or similar process.

In S754, the control unit 101 of each of the imaging apparatuses 100 acting as slaves performs the actual shooting.

In S715, the control unit 101 of the master imaging apparatus 100 transitions to S716 if it is determined by the subject identification unit 111 that the subject is a subject for which post-capture is implemented. At this time, the control unit 101 of the master imaging apparatus 100 issues, through the communication unit 404, an instruction command to implement post-capture to the two other imaging apparatuses 100 acting as slaves. In contrast, if it is determined that the subject is a subject for which no post-capture is implemented, the control unit 101 transitions to S717.

In S717, if pre-capture images are recorded in the system memory unit 106, the control unit 101 of the master imaging apparatus 100 saves the pre-capture images and the actual shooting image obtained in S714 in the external recording unit 107. Note that, if a post-capture image is obtained in S716, it is similarly saved in the external recording unit 107.

In S718, the control unit 101 of the master imaging apparatus 100 deletes all of the pre-capture images recorded in the system memory unit 106. Thereafter, the control unit 101 returns to S702 to repeat the flow.

In contrast, in S755, the control unit 101 of each of the imaging apparatuses 100 acting as slaves determines whether an instruction command to implement post-capture has been received from the master imaging apparatus 100. If an instruction command to implement post-capture has been received, the control unit 101 transitions to S756. In contrast, if an instruction command to implement post-capture has not been received, the control unit 101 transitions to S757.

In S757, if pre-capture images are recorded in the system memory unit 106, the control unit 101 of each of the imaging apparatuses 100 acting as slaves saves the pre-capture images and the actual shooting image obtained in S754 in the external recording unit 107. Note that, if a post-capture image is obtained in S756, it is similarly saved in the external recording unit 107.

In S758, the control unit 101 of each of the imaging apparatuses 100 acting as slaves deletes all of the pre-capture images recorded in the system memory unit 106. Thereafter, the control unit 101 returns to S752 to repeat the flow.

According to the present embodiment, when shooting with a plurality of imaging apparatuses using the pre-capture function, if a single imaging apparatus that acts as a master transitions to the pre-capture shooting mode, it is possible to automatically cause the other imaging apparatuses that act as slaves to transition to the pre-capture shooting mode. Although the imaging apparatuses of the present embodiment have been described using the imaging apparatus 100, it is permissible to use the imaging apparatus 400 described in the second embodiment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-051689, filed Mar. 28, 2023, and No. 2023-222018, filed Dec. 27, 2023, which are hereby incorporated by reference herein in their entirety.

What is claimed is:

1. An electronic apparatus comprising:
at least one processor causing the electronic apparatus to act as:
an operation unit configured to output a first operation instruction instructing preparation for shooting, and a second operation instruction instructing recording of a captured image;
a storage unit configured to temporarily retain image data output from an imaging unit while the first operation instruction is being output;
an identification unit configured to identify a subject;
a control unit configured to, while the first operation instruction is being output, execute control to capture the image data by the imaging unit and retain the image data in the storage unit based on identification information of the identification unit; and
a recording unit configured to, when the second operation instruction is output, record, onto a recording medium, image data of an image captured by the imaging unit in response to the second operation instruction, and image data retained in the storage unit at a timing closest to when the second operation instruction is output.

2. The electronic apparatus according to claim 1, wherein the identification unit is configured to identify the subject based on an output from the imaging unit.

3. The electronic apparatus according to claim 2, wherein a cycle of subject identification by the identification unit is set in accordance with a driving mode of the imaging unit.

4. The electronic apparatus according to claim 2, wherein identification of the subject includes detection of a smile of the subject.

5. The electronic apparatus according to claim 1, wherein, when the subject is identified as a moving subject by the identification unit, the control unit is configured to execute control to capture the image data by the imaging unit and retain the image data in the storage unit while the first operation instruction is being output.

6. The electronic apparatus according to claim 1, wherein the control unit is configured to set a number of shots based on identification information of the identification unit.

7. The electronic apparatus according to claim 1, wherein identification of the subject includes a vehicle.

8. The electronic apparatus according to claim 1, wherein identification of the subject includes an animal.

9. The electronic apparatus according to claim 1, wherein the identification unit is configured to identify the subject based on an output from a sensor different from the imaging unit.

10. The electronic apparatus according to claim 9, wherein the sensor is an event sensor configured to output only information on a pixel that has had a luminance change.

11. The electronic apparatus according to claim 9, wherein the sensor is a thermosensor for detecting a temperature of the subject.

12. The electronic apparatus according to claim 1, further comprising:
a communication unit configured to communicate with an external device,
wherein, among a plurality of the electronic apparatuses, when an electronic apparatus acting as a master enables a pre-capture function, the electronic apparatus acting as a master issues, through the communication unit, a command to enable the pre-capture function to the remaining electronic apparatuses acting as slaves.

13. A control method for an electronic apparatus, the control method comprising:
of a first operation instruction instructing preparation for shooting and a second operation instruction instructing recording of a captured image, which are output from an operation unit, detecting the first operation instruction;
temporarily retaining image data output from an imaging unit in a storage unit while the first operation instruction is being output;
identifying a subject;
while the first operation instruction is being output, executing control to capture the image data by the imaging unit and retain the image data in the storage unit based on identification information in the identifying;
detecting the second operation instruction; and
when the second operation instruction is output, recording, onto a recording medium, image data of an image captured by the imaging unit in response to the second operation instruction, and image data retained in the storage unit at a timing closest to when the second operation instruction is output.

14. A non-transitory computer-readable storage medium storing a program including instructions, which when executed by one or more processors of an electronic apparatus, cause the electronic apparatus to perform a control method comprising:
of a first operation instruction instructing preparation for shooting and a second operation instruction instructing recording of a captured image, which are output from an operation unit, detecting the first operation instruction;
temporarily retaining image data output from an imaging unit in a storage unit while the first operation instruction is being output;
identifying a subject;
while the first operation instruction is being output, executing control to capture the image data by the imaging unit and retain the image data in the storage unit based on identification information in the identifying;
detecting the second operation instruction; and
when the second operation instruction is output, recording, onto a recording medium, image data of an image captured by the imaging unit in response to the second operation instruction, and image data retained in the storage unit at a timing closest to when the second operation instruction is output.
